(19) United States
(12) Patent Application Publication
(10) Pub. No.: US 2004/0061298 A1
(43) Pub. Date: Apr. 1, 2004

(54) Tool caddy

(76) Inventor: Peter A. Sandoval, Chimayo, NM (US)

Correspondence Address: Stephen R. Greiner, Esquire, GREINER LAW OFFICES, P.C., Suite 110, 6701 Democracy Blvd., Bethesda, MD, 20817, US

(21) Appl. No.: 10/255,687

(22) Filed: Sep. 27, 2002

(51) Int. Cl. B62B 1/06

(52) U.S. Cl. 280/47.27

(57) ABSTRACT

A tool caddy including a pair of hinged arms for encircling a trashcan. A mounting bracket is hingedly secured to the inner end of each of the hinged arms for releasably securing the arm to a hand truck. A pair of cooperating locking elements is positioned at the outer ends of the hinged arms for releasably joining the hinged arms together. At least one clip is secured to one of the hinged arms for releasably grasping and carrying a tool.

### FIELD OF THE INVENTION

The present invention relates generally to hand-propelled, wheeled vehicles and, more particularly, to plural load supports used therewith.

### BACKGROUND OF THE INVENTION

Gardeners have long used trashcans to haul their tools and to collect debris. To further reduce their labors, many gardeners have taken to employing conventional hand trucks and wagons to move tool- and debris-filled trashcans over the ground. Special-purpose dollies have been proposed for the purpose of toting trashcans and long-handled garden tools like rakes, shovels and brooms, but these have not seen widespread acceptance or great commercial success.

Conventional hand trucks and wagons lack means for securing trashcans in place and for supporting gardening tools remote from a trashcan. Bungee cords are, thus, used to weakly secure a trashcan in place on a hand truck or wagon. Furthermore, gardening tools are often carried along with garden waste in a trashcan positioned on a hand truck or wagon. Unfortunately, tools that are small in size are sometimes buried in the waste, forgotten and discarded.

Special purpose dollies pose a number of problems for users. Perhaps their principal problem is that trashcans are more-or-less permanently secured thereto, making the emptying of accumulated trash and garden debris a time-consuming and burdensome task. Furthermore, these dollies cannot be converted to normal use whereby items other than trashcans and a few tools can be easily transported. Finally, these dollies are costly and cumbersome in their construction. One does not often see them in use.

### SUMMARY OF THE INVENTION

In light of the problems associated with the known products for hauling trashcans and gardening tools around a lawn or garden, it is a principal object of the invention to provide a tool caddy that can be selectively attached to a conventional hand truck such that, in an open configuration, a trashcan and a plurality of tools can be carried by the hand truck for ready use and, in a collapsed configuration, the hand truck can be employed in a normal manner to transport items of any sort.

It is another object of the invention to provide a tool caddy of the type described that permits a trashcan to be easily attached and detached from the hand truck to which the tool caddy is mounted. Thus, scooping materials into such a trashcan or dumping materials from the trashcan can be accomplished in an unencumbered manner, free of a hand truck. Any tools carried by the tool caddy need not be detached therefrom to attach or detach the trashcan.

It is a further object of the invention to provide a tool caddy of the type described that can be universally mounted upon hand trucks of many different makes and models. Mounting of the tool caddy can be accomplished with minimal instruction and without tools of any sort. The tool caddy can also be used with trashcans of varied design.

It is still another object of the invention to provide a tool caddy that permits the location of the tools carried thereby to be varied somewhat so as to accommodate one another without binding.

It is an object of the invention to provide improved elements and arrangements thereof in a tool caddy for the purposes described which is lightweight in construction, inexpensive to manufacture, and dependable in use.

Briefly, the tool caddy in accordance with this invention achieves the intended objects by featuring a pair of hinged arms adapted to encircle a trashcan. Each of the hinged arms has an inner portion hingedly secured to an outer portion. A pair of mounting brackets is provided for releasably securing the hinged arms to a hand truck. Each of the mounting brackets is hingedly secured to the inner portion of one of the hinged arms. Each of the mounting brackets has a strap for encircling one of a pair of hand truck uprights and a threaded fastener penetrating the strap and retaining the strap in an upright-encircling condition. A pair of cooperating locking elements is positioned on the outer portions of the hinged arms for releasably joining the hinged arms together. A number of clips is secured to the hinged arms for releasably grasping at least an equal number of tools.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a side view of a tool caddy in accordance with the present invention supporting a trashcan on a wheeled dolly.

FIG. 2 is a front view of the tool caddy, with portions broken away, on a wheeled dolly.

FIG. 3 is a top view of the tool caddy on a wheeled dolly.

FIG. 4 is a tool-carrying clamp used with the wheeled dolly.

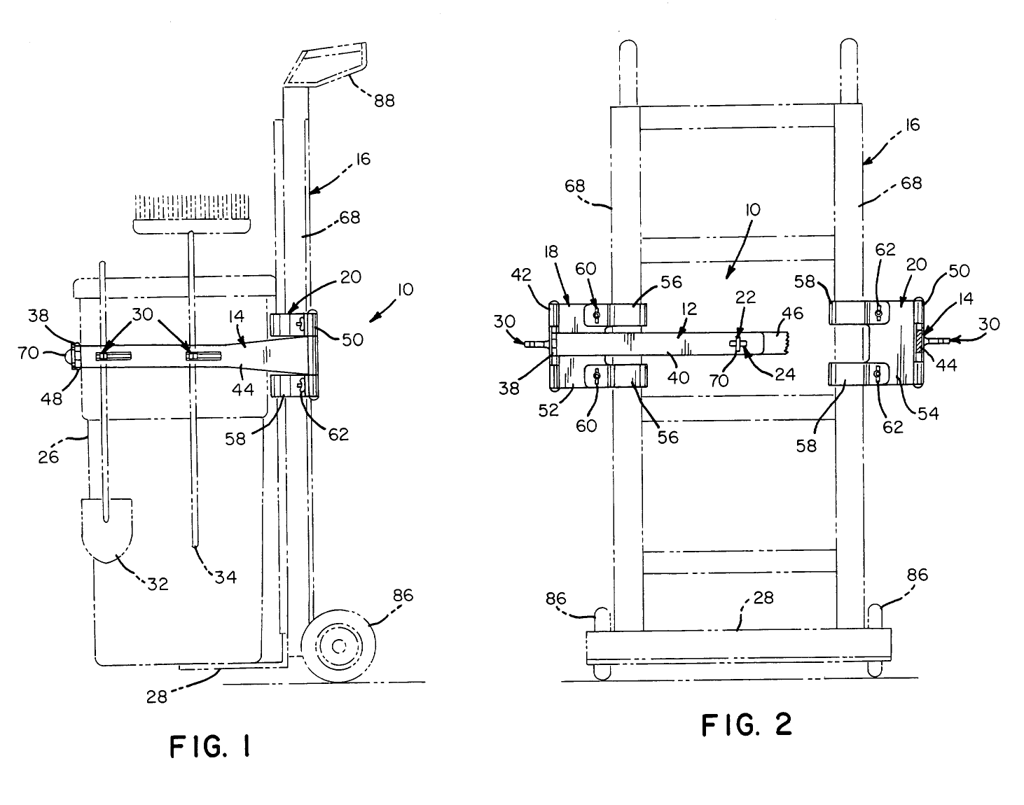

Similar reference characters denote corresponding features consistently throughout the accompanying drawings.

### DETAILED DESCRIPTION OF THE PREFERRED EMBODIMENT

Referring now to the FIGS., a tool caddy in accordance with the present invention is shown at 10. Tool caddy 10 includes a pair of hinged arms 12 and 14 that may be releasably secured to a hand truck 16 by means of mounting brackets 18 and 20 at the inner ends of arms 12 and 14. The outer ends of arms 12 and 14 are provided with cooperating locking elements 22 and 24 that permit arms 12 and 14 to be releasably joined together in a U-shaped arrangement so as to encircle a trashcan 26 on lifting platform 28 of hand truck 16. Each of arms 12 and 14 carries a pair of clips 30 for releasably grasping garden tools like a shovel 32 and a rake 34.

Hinged arm 12 includes an inner portion 36 secured by means of a hinge 38 to an outer portion 40. As shown, portions 36 and 40 are rigid bars of substantially equal length. Hinge 38 permits portions 36 and 40 to be positioned at any angle within a range of motion approaching three hundred and sixty degrees. Another hinge 42 secures portion 36 to mounting bracket 18 and permits portion 36 to be positioned relative to mounting bracket 18 at any angle within virtually a 360° range of motion.

Hinged arm 14 includes an inner and outer portions 44 and 46 secured together by a hinge 48. Portions 44 and 46 are rigid bars of substantially equal length. Hinge 48 permits portions 44 and 46 to be positioned at any angle within a range of motion of about three hundred and sixty degrees. Another hinge 50 secures portion 44 to mounting bracket 20 and permits portion 44 to be positioned relative to mounting bracket 20 at any angle within nearly a 360° range of motion.

Mounting brackets 18 and 20 include base plates 52 and 54 to the outer ends of which hinges 42 and 50 are respectively secured. Extending from the inner ends of base plates 52 and 54 are pairs of straps 56 and 58 that are folded back upon base plates 52 and 54 and secured by means of threaded fasteners, i.e., wing nuts 60 and 62 so as to form loops as at 64 and 66. Loops 64 and 66 are sized to snugly encircle and grasp the twin uprights 68 of hand truck 16.

Cooperating locking elements 22 and 24 define a simple latch. As shown, locking element 22 comprises a lever 70 secured to the front of a retaining pin 72 that is free to rotate with respect to outer portion 46. Locking element 24, however, is a slot in outer portion 40 that is sized, shaped and positioned for the full passage of horizontally oriented lever 70 only when outer portions 40 and 46 are brought into abutment with one another as illustrated in the FIGS. After the passage of lever 70 through slot 24, lever 70 can be rotated to a vertical orientation that will prevent its passage through slot 24 and will selectively secure outer portions 40 and 46 together.

Each of clips 30 includes a pair of jaw members 74 and 76 that are pivotally secured together by a pivot pin 78. A spring 80 coiled around pivot pin 78 and engaging jaw members 74 and 76 biases the outer ends of jaw members 74 and 76 against one another so that the handle of a tool like shovel 32 or broom 34 can be grasped therebetween. The inner end of jaw member 74 is provided with a pair of inwardly directed lips 82 between which can be grasped the top and bottom surfaces of a guide rail 84. Lips 82 are free to slide along a guide rail 84 affixed to one of the inner portions 36 and 44 of arms 12 and 14 extending along the length thereof.

From the foregoing, it should be appreciated that mounting tool caddy 10 on hand truck 16 is straightforward. First, trashcan 26 is positioned upon hand truck 16. Then, locking elements 22 and 24 are mated so as to join outer portions 40 and 46 together. Finally, mounting brackets 18 and 20 are secured to hand truck 16 proximate the top of trashcan 26 by wrapping straps 56 and 58 around uprights 68 and tightening wing nuts 60 and 62 to hold loops 64 and 66 in place. Although mounting brackets 18 and 20 are shown in the FIGS. to be positioned parallel to outer portions 40 and 46 when the mounting of tool caddy 10 is concluded, brackets 18 and 20 can be pivoted forward or back on uprights 68 to bring outer portions 40 and 46 into snug engagement with trashcans having dimensions different from those of trashcan 26.

Tools like shovel 32 and broom 34 are simply pressed into clips 30 carried by arms 12 and 14 to secure such adjacent trashcan 26. If the tools prove to be too close to one another, they may be moved apart by sliding clips 30 along guide rails 84 to more suitable locations. When a tool is needed, it is simply pulled from the associated clip 30 with jaw members 74 and 76 opening as the biasing force of spring 80 is overcome.

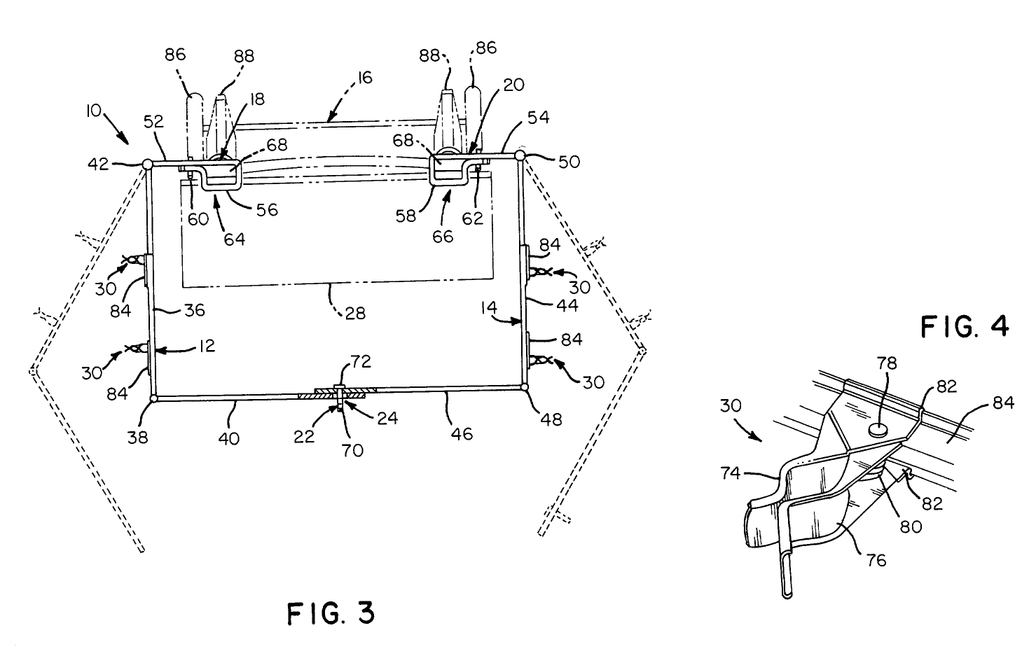

Should trashcan 26 become filled with lawn and garden debris during the course of its use, it can be hauled on hand truck 16 with little likelihood of spilling (because joined arms 12 and 14 prevent trashcan upset) to a chosen spot for emptying. Then, locking elements 22 and 24 can be released from one another and arms 12 and 14 pivoted to the broken line position of FIG. 3 where trashcan 26 is released from hand truck 16. Trashcan 26 can now be emptied in the normal manner. Any tools retained by clips 20 need not be disengaged from tool caddy 10 to accomplish this task.

If it is desired that hand truck 10 be used to move a tree or shrub, for example, trashcan 26 would not be needed and would be set aside. Arms 12 and 14 would, then, be collapsed upon themselves with portions 36 and 40 as well as 44 and 46 being placed in abutment with one another. Next, the collapsed arms 12 and 14 would be pivoted rearwardly to a compact stowage position beneath the wheels 86 and handgrips 88 of hand truck 16 so as to not engage the shrub (not shown). The shrub would now be positioned on the lifting platform 28 of the hand truck 16 and moved without impediment from arms 12 and 14. Arms 12 and 14 always remain ready to be extended forwardly for future use in moving trashcan 26 and tools 32 and 34.

While the invention has been described with a high degree of particularity, it will be appreciated by those skilled in the art that modifications may be made thereto. For example, clips 30 may be replaced by any functional equivalent and may be rigidly affixed to arms 12 and 14 or permitted to move along the length of arms 12 and 14 as may be desired by a user. Therefore, it is to be understood that the present invention is not limited to the sole embodiment described above, but encompasses any and all embodiments within the scope of the following claims.

I claim:

1. A tool caddy, comprising:
a pair of hinged arms adapted to encircle a trashcan, each of said hinged arms having an inner end and an outer end;
a pair of mounting brackets for releasably securing said hinged arms to a hand truck, each of said mounting brackets being secured to said inner end of a respective one of said hinged arms;
a pair of cooperating locking elements positioned at said outer ends of said hinged arms for releasably joining said outer ends of said hinged arms together; and,
a clip secured to one of said hinged arms for releasably grasping a tool.

2. A tool caddy, comprising:
a pair of hinged arms adapted to encircle a trashcan, each of said hinged arms having an inner portion hingedly secured to an outer portion;
a pair of mounting brackets for releasably securing said hinged arms to a hand truck, each of said mounting brackets being hingedly secured to said inner portion of a respective one of said hinged arms, each of said mounting brackets including a strap for encircling the upright of a hand truck and a threaded fastener penetrating said strap and retaining said strap in an upright-encircling condition;
a pair of cooperating locking elements positioned on said outer portions of said hinged arms for releasably joining said hinged arms together; and,
a plurality of clips secured to said hinged arms for releasably grasping a plurality of tools.

3. The tool caddy according to claim 2 wherein said clip is slidably secured to one of said hinged arms.

4. A tool caddy, comprising:
a pair of hinged arms adapted to encircle a trashcan, each of said hinged arms having an inner portion hingedly secured to an outer portion;
means for securing said inner portions of hinged arms to a hand truck;
means for releasably joining said outer portions of said hinged arms together; and,
a clip secured to one of said hinged arms for releasably grasping a tool.
